(19) United States
(12) Patent Application Publication
(10) Pub. No.: US 2006/0161955 A1
(43) Pub. Date: Jul. 20, 2006

(54) Linking of interactive television recording to applications

(76) Inventors: Philip Steven Newton, Eindhoven (NL); Declan Patrick Kelly, Shanghai (CN); Wilhelmus Jacobus Van Gestel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,898

(22) PCT Filed: Jun. 30, 2004
(86) PCT No.: PCT/IB04/51058

§ 371 Date: Dec. 29, 2005

(30) Foreign Application Priority Data
Jul. 2, 2003 (EP) 031019763

(51) Int. Cl. H04N 5/445; G06F 3/00; G06F 13/00; H04N 7/173

(52) U.S. Cl. 725/58; 725/88

(57) ABSTRACT

A method and computer-readable medium of handling recording of interactive television, such as MHP, wherein interactive television applications may initiate recording of interactive television content. The interactive television is tagged with information linking the content to the application that made the recording for access control purposes. In this way applications can see which recorded content is related to the application. Thus access is limited for applications to related recorded content. Furthermore an application may select between different parts of a multi-part program, such as a series of television programs.

This invention relates in general to the field of interactive television and more particularly to the recording and playback of interactive television contents and even more particularly to handling of applications in the field of recording and playback of interactive television contents.

Interactive television (iTV) is becoming more and more popular. An example of interactive television is the Multimedia Home Platform (MHP), which is a digital video broadcasting (DVB) standard intended to combine digital television (DTV) with interactivity and access to the Internet and the World Wide Web. MHP is a standard for iTV that specifies the functionality available to applications that are designed to operate on devices that support MHP. MHP is based on the Java platform, and it extends the Java platform with libraries specific to a digital iTV platform. MHP is typically designed for use on set-top boxes. The current version of the standard does not provide functionality for recording applications and audio/video content. MHP is based solely on live broadcast.

In the upcoming new version of the MHP 2.0 Personal Digital Recorder (PDR) functionality will be integrated. Similar to today's video recorders for analogue television broadcasts using video tapes for recording broadcast streams, these digital video recorders for interactive television are either using fixed storage media, such as a harddisk, or removable media, such as optical discs, for storing recorded broadcasts. PDR's for interactive television record both A/V television contents and applications for playback at a later point in time. For MHP applications that will make use of this new functionality this means that they will be able to make recordings, obtain information on stored programmes and obtain background information on the content. MHP applications may also be recorded themselves and will have access to own data files.

DTV service providers offer a large variety of audio-visual (A/V) television programs and also of MHP applications allowing the interaction of the viewer/user with the TV set and its contents, wherein MHP applications can be divided into the two categories of service-bound and non-service bound applications.

Non-service bound applications are applications that provide interactivity on their own merit. They are not tied to content, they provide functionality to the user independent of the content. Examples of service-bound applications are: electronic program guides EPG's, gambling for instance related to a quiz show or a sports event, chat, e-mail, games, etc. For instance is an EPG an application used with e.g. digital set-top boxes to list current and scheduled programs that are or will be available on broadcast channels, which may be received by the set-top boxes. The EPG comprises e.g. a short summary or commentary for each program and is the electronic equivalent of a printed television program guide.

Service-bound applications are applications that are strongly related to the content, wherein content generally is the audio/video transmitted together with the application. This type of applications only has relevance if the associated content is available. Therefore, service-bound applications in general will be recorded together with the associated content. However, some service-bound applications may be related not to one but to several audio/video streams stored on e.g. a single storage medium. An example is an application that allows a user to select to view an episode of a series. For instance are several episodes of the series recorded at different points in time, e.g. daily or weekly. The entire number of episodes is recorded to the same storage medium. It is desired that the application offered the user the possibility to choose a certain episode of the stored episodes for viewing. Therefore it is a problem that the application is only recorded together with the associated content, i.e. a single broadcast episode broadcast and recorded concurrently with that application, and is not capable of recognising the remaining content. For instance other episodes on the same storage medium are not accessible from an identical or similar application other than the one recorded together with the specific episode. The application is only related to one single audio/video stream. Therefore there is a need for the application being able to see all related content, e.g. all recorded episodes, on a storage medium. Moreover it is a problem that recorded content may be deleted from a storage medium but not the associated application. This may result in an unstable system when an application is run without the associated content available on the storage medium.

Another problem is that it is time consuming to load an application into memory. This is the case because each time an audio/visual stream is run, the associated application is loaded into memory for running.

It is also desired that the application gives the viewer the option of playing the other episodes.

Thus, there is a need for a new way of recording iTV applications and content to storage media and/or playing back iTV recordings comprising applications and related content from the storage media.

The present invention overcomes the above-identified deficiencies in the art and solves at least the above identified problems by providing a method and a computer readable medium according to the appended patent claims.

The general solution according to the invention is to tag recorded interactive television content with identification information for access control to the recorded iTV content. More specifically, recordings that are initiated by an application are tagged with the application that caused the recording and the broadcaster who broadcast the application. This allows an application to see which other programmes that are stored are related to the application and allows the user to navigate between those. It also allows the system to ensure that an application can only access the files that are linked to it so that one application cannot delete or modify the files from another application.

According to aspects of the invention, a method and a computer-readable medium for handling of recording and/or playback of interactive television are disclosed. According to one aspect of the invention, a method for handling of recording and/or playback of interactive television is provided, wherein recorded interactive television content is tagged with identification information for access control to the interactive television content.

According to a further aspect of the invention, a computer-readable medium having embodied thereon a computer program for processing by a computer is provided for performing the method according to the invention. The computer program comprises a code segment for tagging of recorded interactive television content with identification information for access control to the recorded interactive television content.

The present invention has the advantage over the prior art that it allows restricted access to recorded interactive television content. Only the interactive television application, which recorded a interactive television content may modify or delete the interactive television content associated with the application.

A further advantage is that the present invention allows the selection between different parts of a multi-part program, such a television series.

Yet a further advantage of the present invention is that an application already in memory does not have to be re-loaded into memory when playing another part of a multi-part program, as it is already loaded into memory.

Further objects, features and advantages of the invention will become apparent from the following description of embodiments of the present invention, reference being made to the accompanying drawings, in which

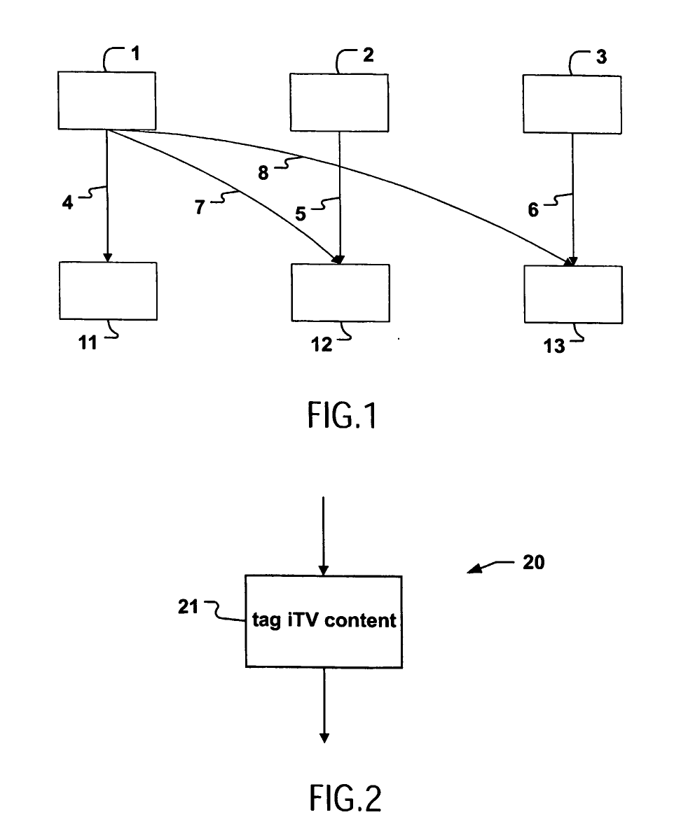

FIG. 1 is a schematic diagram illustrating the principle of the invention,

FIG. 2 is a flow chart illustrating a method according to an embodiment of the invention, and

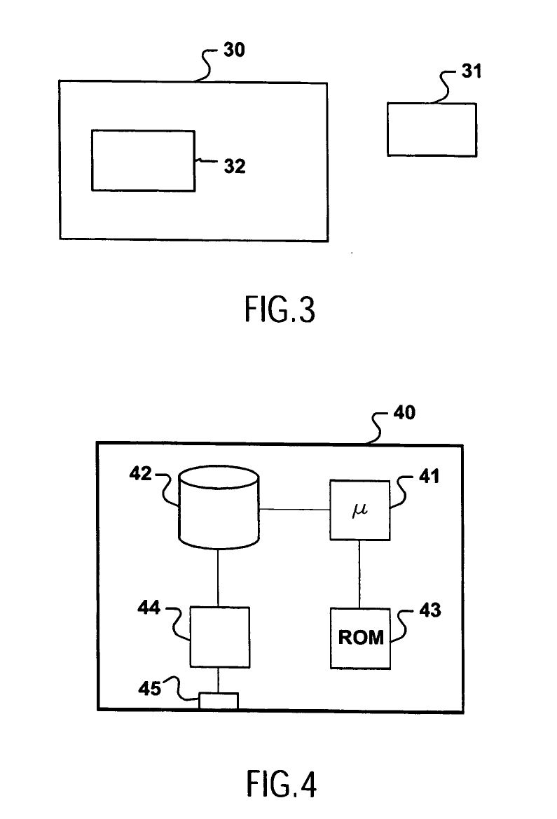

FIG. 3 is a schematic diagram showing a computer-readable medium according to another embodiment of the invention, and

FIG. 4 is schematic diagram showing an embodiment of the apparatus according to the invention.

FIG. 1 is a schematic diagram illustrating the principle of the invention, wherein a first interactive television application 1 is related to an interactive television audio/visual stream 11, as indicated by arrow 4. The first interactive television application 1 is shown being related to two further interactive television applications 2, 3 and two further interactive television audio/video streams 12, 13, as indicated by the arrows 7, 8, wherein the further interactive television applications are related to the interactive television audio/video streams 12, 13 respectively, as indicated by the arrows 5,6. The interactive television applications 1, 2 and 3, recorded the associated interactive television streams 11, 12 and 13 at different times to a single storage medium. The interactive applications 1, 2 and 3 are also recorded to the storage medium. However, these applications are stored outside the transportstream (TS), i.e. separate from the A/V content 11, 12, 13. When the applications are broadcast as files, e.g. through a DSMCC carousel, the interactive application files are extracted from the transportstream during recording and stored separately. Preferably an additional file is generated, referred to as MHP info file, for example in XML format. The MHP info file describes how and where the interactive application files are stored on the storage medium and also the timing relationship between the interactive application and the A/V content. The MHP info file is always linked to the application. Additionally, an extra table is added to the MHP info file that lists the ID's of the related streams for this application. The table may for instance have the following structure:

<RelatedStreams>

<ID>0</ID>
<ID>34</ID>

</RelatedStreams>

In the example, illustrated in FIG. 1, the interactive television applications 1, 2 and 3 are very similar, they add the same interactivity to the content, which is located in the AV streams 11, 12 and 13. All three interactive television applications 1, 2 and 3 originate from the same broadcaster. The interactive television streams 11, 12 and 13 are tagged with information on the application 1, 2 or 3 respectively, which recorded them. The first application 1 knows about the other recorded streams as these are recorded on the same storage medium. Thus the first application 1 may give a user the option to also see the other streams 12, 13, which may are episodes of a series, as described above. The other interactive television applications 2, 3 do also have access to the remaining other interactive television streams 11, 13 and 12, 13 respectively. However, only the interactive television application having initiated the recording of an interactive television stream may modify the recorded stream in order to exclude undesired modifications or deletion of stored interactive television streams.

In the case of MHP, MHP applications have access to files through storage Application Programming Interfaces (API's). The streams are recorded as files. API's define the publicly accessible surface of software classes through which applications operate upon the specific functions contained within the MHP. When an application requests to see a list of files, the system will only return entries for the files that are tagged with the application. To tag a file with an application during recording, the system will built up a file table that links an applicationID with a list of files that are related to the recorded application. These are for instance data files, images or recorded streams.

An embodiment of the invention is illustrated in FIG. 2, wherein a method 20 handling recording and/or playback of interactive television according to the above principle, comprises a step 21 of tagging recorded interactive television content with identification information for access control to the recorded interactive television content.

In another embodiment of the invention according to FIG. 3, a computer-readable medium 30 is provided having embodied thereon a computer program for processing by a computer 31. The computer program is performing above described method and comprises a code segment 32 for tagging of recorded interactive television content with identification information for access control to the recorded interactive television content.

FIG. 4 shows an embodiment of the apparatus according to the invention, which is digital video recorder 40. The digital video recorder 40 comprises a central processing unit 41, a harddisk drive 42 as a memory, a ROM 43 (Read Only Memory), a video processing circuit 44 and an output 45.

In the ROM 43, the code element 32 (FIG. 3) is stored, enabling the central processing unit 41 to be programmed to execute the method described above. With this method, interactive television stored in the harddisk drive 42 is tagged.

Interactive television content is retrieved from the harddisk drive 42 upon a user request and processed by the video processing circuit 44. The output signal of the video processing circuit 44 is send to the output 45, from which it can be sent bo a TV-set (not shown).

Applications and use of the above described tagging of recorded interactive television content according to the invention are various and include exemplary application such as personal digital video recorders, enhanced set-top boxes, etc.

The present invention has been described above with reference to specific embodiments. However, other embodiments than the preferred above are equally possible within the scope of the appended claims, e.g. different ways of storing the identification information along with the interactive television content than those described above, performing the above method by hardware or software, etc.

Furthermore, the term “comprises/comprising” when used in this specification does not exclude other elements or steps, the terms “a” and “an” do not exclude a plurality and a single processor or other units may fulfil the functions of several of the units or circuits recited in the claims.

1. A method of recording and/or playback of recorded interactive television, comprising
tagging of recorded interactive television content with identification information for access control to the recorded interactive television content.

2. The method according to claim 1, wherein said interactive television content is audio/visual content associated to an interactive television application.

3. The method according to claim 2, comprising
causing recording of said interactive television content by said interactive television application.

4. The method according to claim 3, said identification information being information identifying said application that caused the recording.

5. The method according to claim 3, said identification information being information identifying a broadcaster who broadcast said application and said recorded interactive television content for recording.

6. The method according to claim 2, comprising indicating to a play-back application for playing back interactive television content which other interactive television content stored on a storage medium is related to said play-back application by means of said identification information.

7. The method according to claim 6, comprising said play-back application allowing a user to navigate between a plurality of said stored related interactive television content.

8. The method according to claim 1 comprising controlling access to said recorded interactive television content in such a manner that recorded interactive television content may only be deleted or modified by an application that recorded said interactive television content.

9. The method according to claim 1, wherein said interactive television content is recorded as files.

10. The method according to claim 9, comprising storing said interactive television content, said interactive television application and said identification information in separate files.

11. The method according to claim 10, wherein said identification information is stored in an info file being linked to at least one interactive television application, comprising a table with related interactive television content to said interactive television application on said storage medium.

12. The method according to claim 1, wherein said interactive television is MHP.

13. The method according to claim 1, said interactive television content being at least one audio/visual stream.

14. A computer-readable medium having embodied thereon a computer program for processing by a computer, the computer program, when used, being for performing the method according to claim 1, comprising
a code segment for tagging of recorded interactive television content with identification information for access control to the recorded interactive television content.

15. Use of a Personal Digital Recorder with the computer program according to claim 1.

16. Use of recorded interactive television content tagged with identification information for access control to the recorded interactive television content.

17. Apparatus for recording and/or playback of recorded interactive television, comprising:
a memory for storing interactive television content.
a central processing unit, conceived to tag recorded interactive television content with identification information for access control to the recorded interactive television content.
